(19) United States
(12) Patent Application Publication
(10) Pub. No.: US 2016/0251910 A1
(43) Pub. Date: Sep. 1, 2016

(54) RISER BEARING WITH HIGH SHAPE FACTOR

(71) Applicant: LORD CORPORATION, Cary, NC (US)

(72) Inventors: Keith R. PTAK, Erie, PA (US); David C. RIGGS, Coppell, TX (US)

(21) Appl. No.: 15/029,830

(22) PCT Filed: Oct. 29, 2014
(86) PCT No.: PCT/US14/62976

§ 371 Date: Apr. 15, 2016

Related U.S. Application Data
(60) Provisional application No. 61/896,701, filed on Oct. 29, 2013.

(51) Int. Cl. E21B 17/01; E21B 17/04; F16L 27/103

(52) U.S. Cl. CPC E21B 17/01; F16L 27/103; E21B 17/04

(57) ABSTRACT

A flexible joint (200) for use in an offshore hydrocarbon production system (100) having a riser bearing (206) with an elastomeric element (262) within it is provided. The elastomeric element has a high shape factor to combat rapid gas decompression damage to the flexible joint and the elastomeric element.

### TECHNICAL FIELD OF THE INVENTION

The subject matter disclosed herein relates to devices, systems, and methods for reducing and controlling fluid flow in offshore hydrocarbon production. More particularly, the subject matter disclosed herein relates to devices, systems and methods for reducing and controlling rapid gas decompression in flexible riser joints in offshore hydrocarbon production.

### BACKGROUND

Offshore hydrocarbon production systems often comprise a riser, such as a steel catenary riser, that serves as a fluid conduit between a subsea hydrocarbon source and a production structure located substantially near the sea surface. Due to waves, currents, vibrations, internal pressures, and/or a variety of other loads that the production structure and/or the riser may experience, a flexible joint may be employed at the interface between the production structure and the riser to allow relative movement of the riser with respect to the production structure. In some instances, the flexible joint may comprise a riser support bearing within the flexible joint to provide support to the riser during such relative movement. In some cases, the riser support bearing may be exposed to a fluid, such as a hydrocarbon production fluid. As a result of this exposure to the fluid, gases dissolved in the fluid and/or gas produced from a gas injection well received from the riser may permeate into soft elastomeric elements of the riser support bearing. If the hydrocarbon production system needs to shut down for any reason, the pressure within the fluid flow path may generally be reduced at a controlled rate to allow the invasive gases to dissipate out of the elastomeric elements of the riser support bearing. However, if the pressure in the fluid flow path drops too quickly, the gases MAY explosively decompress and generally expand within the elastomeric elements and thus stretch the elastomeric elements to the point of failure.

### SUMMARY

In some embodiments of the disclosure, a riser bearing is disclosed. The riser bearing comprising an inner bonding member, an outer bonding member and at least one elastomeric element. The at least one elastomeric element bonded between the inner bonding member and the outer bonding member. Wherein the elastomeric element has a high shape factor.

In other embodiments of the disclosure, a flexible joint is disclosed. The flexible joint comprising a body, a nipple, and a riser bearing. The riser bearing further comprises an inner bonding member, an outer bonding member and at least one elastomeric element. The at least one elastomeric element bonded between the inner bonding member and the outer bonding member. Wherein the elastomeric element has a high shape factor.

In yet another embodiment, a flexible joint having a seal is disclosed. The flexible joint having a seal comprising a body, a nipple, a riser bearing and a seal bearing. The riser bearing including an inner bonding member, an outer bonding member and at least one elastomeric element. The at least one elastomeric element bonded between the inner bonding member and the outer bonding member. The seal bearing including an inner sealing member, an outer sealing member and at least one elastomeric seal element. The at least one elastomeric seal element bonded between the inner sealing member and the outer sealing member. Wherein the elastomeric seal element has a high shape factor.

### BRIEF DESCRIPTION OF THE DRAWINGS

FIG. 1 is an orthogonal side view of an offshore hydrocarbon production system.

FIG. 2 is an orthogonal cross-sectional side view of a flexible joint.

FIG. 3 is an orthogonal cross-sectional side view of an alternate embodiment of a flexible joint having a bellows seal.

FIG. 4 is an orthogonal cross-sectional side view of another embodiment of a flexible joint having a seal bearing.

FIG. 5 is a detail view from FIG. 2.

FIG. 6 is a detail view from FIG. 4.

### DETAILED DESCRIPTION

In some cases, it is desirable to provide a riser bearing with a high shape factor in a flexible joint of an offshore hydrocarbon production system. For example, where a riser bearing comprises elastomeric elements that may be exposed to hydrocarbon production fluids flowing through the flexible joint, it is desirable to provide a riser bearing having a high shape factor. In that embodiment the flexible joint is resistant to permeation by gases that are dissolved in the fluids thereby preventing rapid gas decompression damage to the riser bearing. In some embodiments, systems and methods are disclosed that provide a multi-layer riser bearing comprising a high shape factor for use in a flexible joint. In some embodiments, the flexible joint may be employed as a component of an offshore hydrocarbon production system.

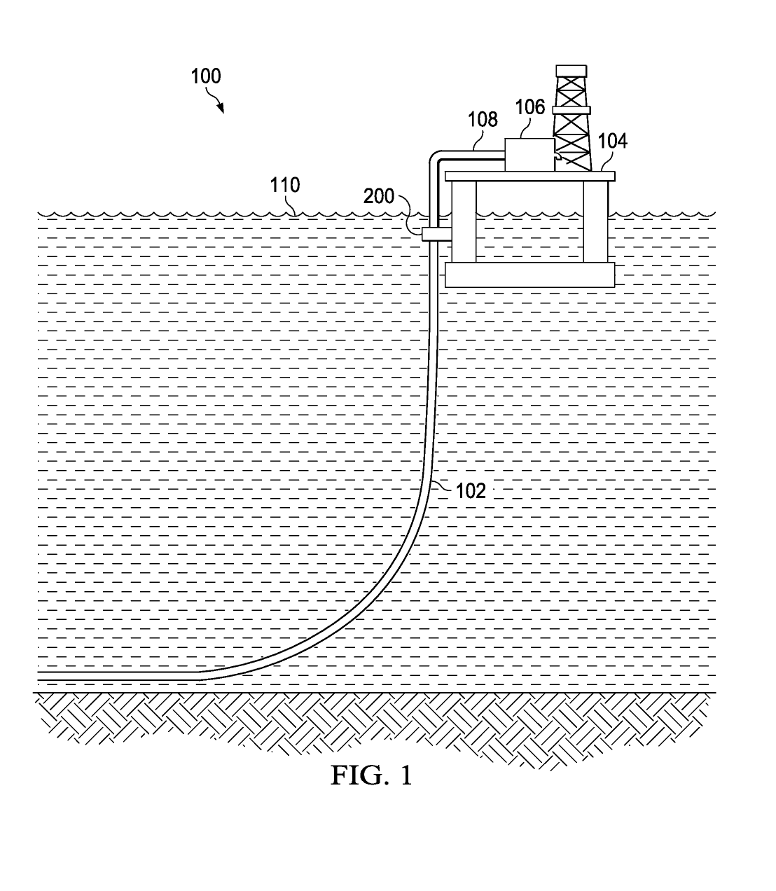

Referring to FIG. 1, an orthogonal side view of an offshore hydrocarbon production system 100 is illustrated. The offshore hydrocarbon production system 100 comprises a fluid conduit 102, a support structure 104 configured to support at least a portion of the weight of the fluid conduit 102, a fluid system 106 configured to selectively connect to the fluid conduit 102 in fluid communication, and a conduit 108 configured to connect the fluid conduit 102 and the fluid system 106 in fluid communication through a flexible joint 200. As illustrated in FIG. 1, support structure 104 is shown floating on water 110. The flexible joint 200 is configured to connect the fluid conduit 102 and the conduit 108 in fluid communication and allow relative movement of the fluid conduit 102 with respect to the support structure 104. In some embodiments, the fluid conduit 102 comprises a riser, such as, but not limited to, a steel catenary riser. In some embodiments, the support structure 104 comprises a buoyant hydrocarbon production rig or platform, a freestanding hydrocarbon production rig, a ship, a helicopter, and/or any other structure that may be located and/or moved relative to the fluid conduit 102 in a manner that may cause a tensile force along the fluid conduit 102 when the fluid conduit 102 is connected to the fluid system 106. In some cases, the above-described tensile force may be partially attributable to a weight of the fluid conduit 102 and/or fluids within the fluid conduit 102. In some cases, the above-described tensile force may be partially attributable to movement of the fluid conduit 102 relative the support structure 104. Additionally, the flexible joint 200 is carried, supported, and/or restrained by the support structure 104 and may be configured to transfer the above-described tensile force to the support structure 104 while also allowing movement of the fluid conduit 102 relative to the support structure 104.

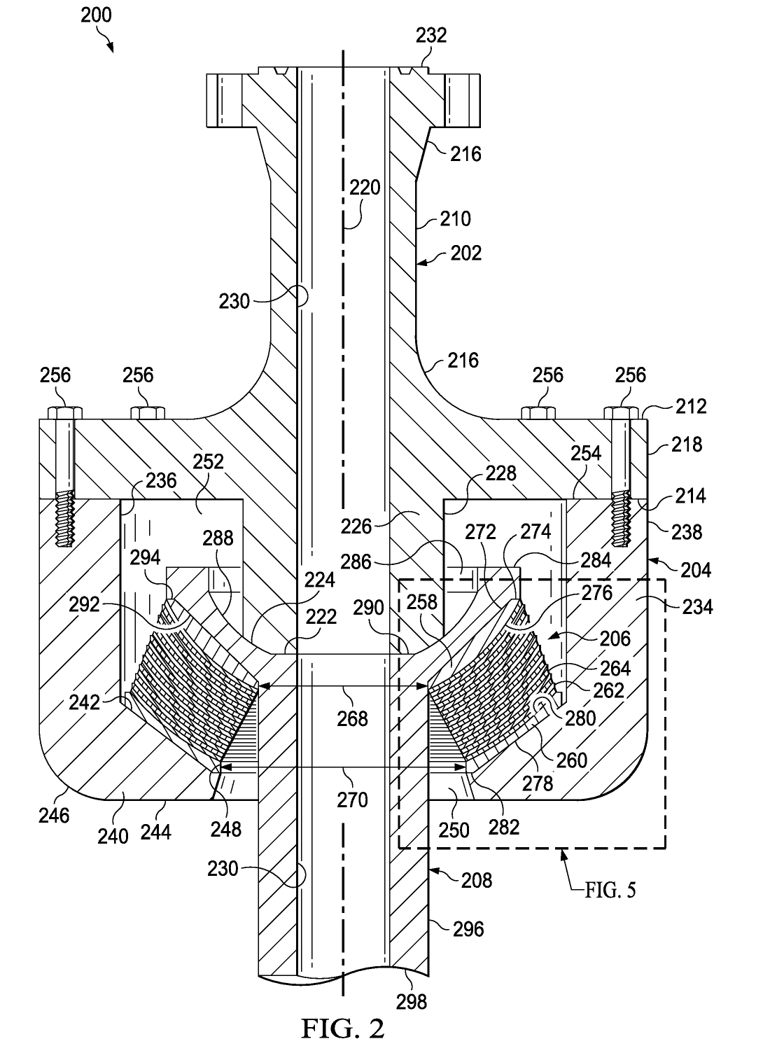

Referring now to FIG. 2 illustrates an orthogonal cross-sectional side view of the flexible joint 200. Flexible joint 200 comprises an upper body 202, a lower body 204, a riser bearing 206, and a nipple 208. Flexible joint 200 also includes a central axis 220 that is shared by the upper body 202, the lower body 204, the riser bearing 206, and the nipple 208. Furthermore, the flexible joint 200 has a central bore 230 defining a fluid flow path through the flexible joint 200 extending coincidentally along central axis 220 from the upper end of the flexible joint 200, through the upper body 202 and the nipple 208, and to the lower end of the flexible joint 200. The central bore 230 is axially aligned with the central axis 220. The upper body 202 of the flexible joint 200 includes a conduit connection end 232 located at an upper end of the upper body 202 and is configured to connect to the conduit 108. While in some embodiments the conduit connection end 232 may comprise a bolted flange, it will be appreciated that any other suitable connection configuration may be used to connect the conduit 108 to the upper body 202 of the flexible joint 200. The upper body 202 also includes an elongated upper portion 210 extending from the conduit connection end 232 to the upper mounting surface 212 along central axis 220. In some embodiments, the elongated upper portion 210 includes elongated upper portion supports 216 located at the interface between the conduit connection end 232 and the elongated upper portion 210 and/or the interface between the elongated upper portion 210 and the upper mounting surface 212. In some embodiments, the elongated upper portion supports 216 include supportive transitions extending from the elongated upper portion 210 to each of the conduit connection end 232 and the upper mounting surface 212. These supportive transitions provide support to the elongated upper portion 210 and allow the elongated upper portion 210 to withstand forces exerted upon the flexible joint 200.

The upper body 202 includes a lower mounting surface 214 substantially opposing the upper mounting surface 212, and provides a mating connection with the lower body 204. The upper body 202 also includes an outer surface 218 that circumferentially bounds the upper mounting surface 212 and the lower mounting surface 214 about central axis 220. An elongated lower portion 226 of the upper body 202 extends along the central axis 220 from the lower mounting surface 214 of the upper body 202 to an upper body base 222 located at the lower end of the upper body 202. The elongated lower portion 226 has an inner surface defined by the central bore 230 and an outer surface defined by the elongated lower portion outer surface 228 circumferentially bounding the elongated lower portion 226 about central axis 220. The elongated lower portion 226 has a spherical interface positioned between the end of the upper body base 222 and the elongated lower portion outer surface 228.

Still referring to FIG. 2, the lower body 204 has an annular wall 234 with an inner wall surface 236 and an outer wall surface 238, each generally coaxial with the central axis 220. The annular wall 234 also has a top wall surface 254 configured to interact with the lower mounting surface 214 of the upper body 202 to provide a fluid-tight seal between the two surfaces 214, 254. In some embodiments, fasteners 256, such as, but not limited to bolts, are employed to secure the upper body 202 to the lower body 204.

The lower body 204 includes a support base 240 generally extending from the annular wall 234 radially towards the central axis 220. The support base 240 has a support base outer surface 244 generally extending perpendicular from the outer wall surface 238 and radially inward towards the central axis 220. In some embodiments, the interface between the outer wall surface 238 and the support base outer surface 244 may comprise a support base radius 246. However, any geometric transition between outer wall surface 238 and support base outer surface 244 is sufficient.

The lower body 204 also includes a clearance bore 250 that is substantially coaxial with the central axis 220 and extends upwardly from the support base outer surface 244 to the body cavity 252 along central axis 220. The clearance bore 250 must be shaped and have sufficient clearance to allow for movement of nipple 208 therein.

In one embodiment support base 240 has a support base inner surface 242 joined at an angle to the inner wall surface 236 such that the support base inner surface 242 slopes toward a lower end of the lower body 204 as the support base inner surface 242 extends radially inward towards the central axis 220. In this configuration, the support base inner surface 242 is at an angle coincident with an orientation angle of the riser bearing 206 such that the riser bearing 206 rests substantially flat against the support base inner surface 242. In one embodiment, the support base inner surface 242 includes a support base lip 248 extending from the support base inner surface 242 radially inward towards the central axis 220 at an angle substantially normal to the central axis 220 and to the clearance bore 250. The support base lip 248 is configured to interact with a complimentary shape of the riser bearing 206 and provide additional support to and/or aid proper location of the riser bearing 206 within the body cavity 252. In alternative embodiments, housing 204 is integrated with outer bonding member 260, and inner boding member 258 is integrated with nipple 208.

Still referring to FIG. 2, the riser bearing 206 comprises an inner bonding member 258, a outer bonding member 260, a plurality of elastomeric elements 262, and a plurality of intermediate shims 264 disposed between adjacent elastomeric elements 262. Intermediate shims 264 have a first side 264a and a second side 264b. The inner bonding member 258 comprises a central bore 268 that is configured to be substantially the same as an outer diameter of nipple 208. The inner bonding member 258 also has a mating surface 272 that is configured to selectively abut a bearing mating surface 292 of the nipple 208. In some embodiments, the mating surface 272 includes an alignment feature 274, such as, but not limited to a bevel that is substantially complimentary to a nipple alignment feature 294 and that is configured to generally locate the nipple 208 with respect to the riser bearing 206. Furthermore, the inner bonding member 258 comprises a bonding surface 276 having a substantially convex profile that is configured to bond to at least one elastomeric element 262. In an alternate embodiment, the convex surface of the bonding surface 276 is configured to maintain a slight radial bend in a plurality of bonded elastomeric elements 262 and intermediate shims 264 that is substantially complimentary to the convex profile of the bonding surface 276. In some embodiments, the inner bonding member 258 is formed from a steel alloy, such as alloys 4130 and 4140, stainless steel, aluminum, titanium, and/or any other suitable material.

The outer bonding member 260 has a central bore 270 providing clearance for movement and/or displacement of the nipple 208 relative to lower body 204 and/or the riser bearing 206. Such movement and/or displacement of the nipple 208 is caused by external forces. The outer bonding member 260 has a mating surface 278 that is substantially flat and abuts the support base inner surface 242 of the lower body 204. In an alternate embodiment, the outer bonding member 260 also includes a alignment feature 282, such as, but not limited to a bevel that is substantially complimentary to the support base lip 248 of the lower body 204. The complimentary shape of the alignment feature 282 and the support base lip 248 properly locates the riser bearing 206 with respect to the lower body 204. In other embodiments, the alignment feature 282 and the support base lip 248 are configured to ensure mating between the mating surface 278 and the support base inner surface 242. Furthermore, the outer bonding member 260 includes a substantially concave bonding surface 280 configured to bond with at least one elastomeric element 262. In some embodiments, the substantially concave profile of the bonding surface 280 has a slight radial bend in the bonded elastomeric elements 262 and intermediate shims 264 to be complimentary to the concave profile of the shim surface 280. The outer bonding member 260 is formed from a steel alloy, such as alloys 4130 and 4140, stainless steel, aluminum, titanium, and/or any other suitable material.

The riser bearing 206 has a plurality of elastomeric elements 262 and a plurality of intermediate shims 264 disposed between and bonded to adjacent elastomeric elements 262. The stacked bonded arrangement of elastomeric elements 262 and intermediate shims 264 is bonded to the inner bonding member 258 and the outer bonding member 260 to form the riser bearing 206. The plurality of elastomeric elements 262 and the plurality of intermediate shims 264 are arranged and bonded together. The high shape factor profile has the elastomeric element 262 bonded to the inner bonding member 258 and increasing in inner diameter up to the elastomeric element 262 that is bonded to the outer bonding member 260. One elastomeric element 262 is bonded to intermediate shim 264 first side 264a and another elastomeric element 262 s bonded to intermediate shim 264 second side 264b. This is repeated for the selected number of elastomeric elements 262 and intermediate shims 264 for riser bearing 206, as those skilled in the art are able to determine The elastomeric elements 262 are formed from an elastomeric material, including, but not limited to natural rubber, nitrile, or any other suitable flexible material compositions. The intermediate shims 264 are formed from a steel alloy, such as alloys 4130 and 4140, stainless steel, aluminum, titanium, fabric, and/or any other suitable material.

The central bore 230 through the nipple 208 is concentric with the central axis 220 and defines a portion of a fluid flow path through the flexible joint 200. The nipple 208 has an upper nipple surface 284 having a receiving bore 286 configured to receive at least a portion of the elongated lower portion 226 of the upper body 202. The receiving bore 286 forms a receiving bore surface 288 and a receiving bore inner surface 290. In one alternative embodiment, the nipple 208 also has an angled bearing mating surface 292 having a generally frustoconical surface that abuts the mating surface 272 of the inner bonding member 258 of the riser bearing 206 when assembled in a state of compressive preloading. The nipple 208 further includes an elongated nipple portion 296 extending from the bearing mating surface 292 along the central axis 220 towards a lower end of the nipple 208. The elongated nipple portion 296 is coaxially aligned with both the central axis 220 and the central bore 230. The elongated nipple portion 296 extends beyond the support base outer surface 244 through the clearance bore 250. At the lower end of the nipple 208, a fluid conduit connection end 298 is configured to connect to a fluid conduit 102.

Still referring to FIG. 2, to assemble the flexible joint 200, the upper body 202 is fastened to the lower body 204 via a plurality of fasteners 256 such that the lower mounting surface 214 of the upper body 202 and the top wall surface 254 of the lower body 204 abut. In some embodiments, abutting or adjoining surfaces may comprise a seal, gasket, and/or other element disposed between the adjoining surfaces. When the flexible joint is assembled as shown in FIG. 2, the components of the flexible joint 200 may be loaded in compression against one another. Generally, the fasteners 256 pull the lower body 204 against the upper body 202. As a result, a compressive force may be applied by the elongated lower portion 226 of the upper body 202 against the receiving bore 286 of the nipple 208. The compressive force applied by the elongated lower portion 226 of the upper body 202 is transferred by the bearing mating surface 292 of the nipple 208 to the riser bearing 206 through the mating surface 272.

In operation, with the flexible joint 200 connected to conduit 108 at the conduit connection end 232 of the upper body 202 and fluid conduit 102 at the fluid conduit connection end 298 of the nipple 208, the weight of the fluid conduit 102 and/or weight of fluid flowing through the fluid conduit 102 displaces the nipple 208 downward along central axis 220 thereby applying additional compression force to the riser bearing 206. As a result, the compressive force caused by the fluid conduit 102 on the elastomeric elements 262 of the riser bearing 206 causes the elastomeric elements 262 to further compress, bulge at an inner and/or outer surface, and/or assume a reduced thickness profile as compared to the thickness profile caused by the assembly preload.

Additionally, the displacement of the nipple 208 generated as a result of the fluid conduit 102 increases separation between mating surfaces of the nipple 208 and the elongated lower portion 226 of the upper body 202 of the flexible joint 200. As a result of the separation between the nipple 208 and the upper body 202, fluid flowing through the central bore 230 flows into the remainder of the body cavity 252, thereby exposing the riser bearing 206 to hydrocarbon fluids and/or gases. The riser bearing 206 is configured to flex and allow movement and/or tilting of the nipple 208 with respect to the upper body 202 and the lower body 204. Generally, the convex profile of the inner bonding member 258 and/or the concave profile of the outer bonding member 260 facilitate angular displacements and/or deflections of the nipple 208 and consequently the riser bearing 206 with respect to the upper body 202 and the lower body 204 of the flexible joint 200. While a typical fatigue deflection of the nipple 208 relative to the central axis 220 may generally be less than 1 degree, in some embodiments, the riser bearing 206 is configured to allow the nipple 208 to deflect at an angle of about at least 10-15 degrees with respect to the upper body 202 and the lower body 204 of the flexible joint 200 when the nipple 208 is connected to the fluid conduit 102.

When the riser bearing 206 conforms to the movement, tilting, and/or deflection of the nipple 208, separation occurs between the mated surfaces of the nipple 208 and the upper body 202. Again, separation of the nipple 208 from the elongated lower portion 226 of the upper body 202 exposes the riser bearing 206 to hydrocarbon fluids and/or gases, flowing through the central bore 230 of the flexible joint 200. Generally, such fluids flowing through the flexible joint 200 may be under pressures from up to about 20,000 pounds per square inch or more. Under these sustained high pressures, gases dissolved in the hydrocarbon fluids and/or the gases flowing through the flexible joint 200, may permeate the elastomeric elements 262 of the riser bearing 206. If rapid depressurization occurs in the flexible joint 200 as a result of damage and/or repair operations, the permeated gas may expand in the elastomeric elements 262, thereby forming expanding gas bubbles. If the gas bubbles expand beyond the strain limits of the elastomeric elements 262, the gas bubbles may cause rapid gas decompression damage, also known as explosive decompression damage, which may result in failure of the elastomeric elements 262, riser bearing 206, and consequently the flexible joint 200.

The riser bearing 206 has a high shape factor, which generally improves resistance to and/or resists rapid gas decompression damage. The high shape factor of riser bearing 206 provides improved resistance to gas permeation into the elastomeric elements 262 as compared to a riser bearing with a low shape factor. The exemplary riser bearing 206 comprises a shape factor of about 15. In alternative embodiments, riser bearing 206 may comprise a high shape factor between about 10 to about 30. In other alternative embodiments, riser bearing 206 has a high shape factor between about 10 to about 40. In some embodiments, individual elastomeric elements 262 may have shape factors different each adjacent elastomeric element 262.

In general, a shape factor indicates the effect of an object's shape on the compressibility and/or deflection of the object when a pressure is applied to it. The shape factor of riser bearing 206 is determined as a function of the properties of the elastomeric elements 262. Thus, the shape factor of riser bearing 206 is determined as the ratio of the loading surface area (bonded surface area) of a elastomeric element 262 as compared to the exposed area that is susceptible to bulging. The exposed bulge area of the elastomeric element 262 is thus determined as the sum of the exposed inner and outer surface areas of the elastomeric element 262. The ratio to determine the shape factor may therefore be determined as the loading surface area divided by the total exposed surface area, where the loading surface area is the numerator and the total exposed surface area is the denominator. Accordingly, the shape factor of an elastomeric element 262 is a function of the inner diameter, outer diameter, and thickness of a particular elastomeric element 262.

Because a shape factor is indicative of the effect of the shape of a elastomeric element 262 on the compressibility and/or deflection of the flexible element when a pressure is applied to it, in some embodiments, a riser bearing 206 including elastomeric elements 262 having a high shape factor are more resistant to compression, thereby allowing a riser bearing 206 to withstand higher loads. In some embodiments, this prevents fatigue damage and improves the lifespan of a riser bearing 206.

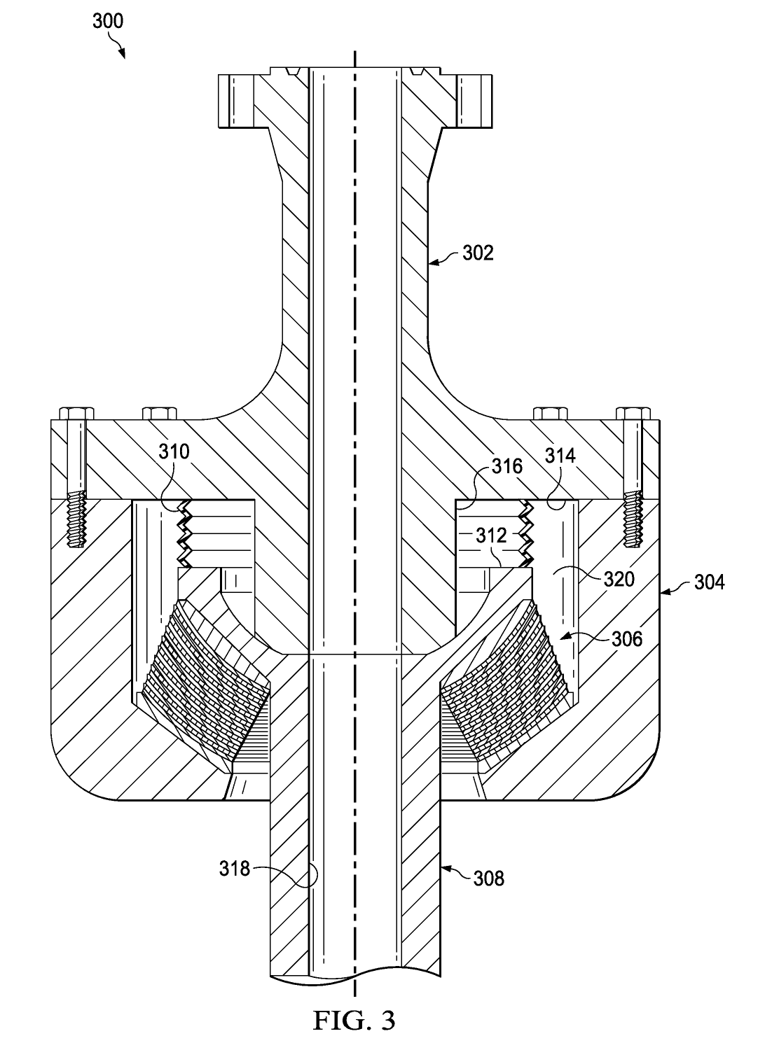

Referring now to FIG. 3, an orthogonal cross-sectional side view of a flexible joint 300 comprising a bellows seal 310 is shown according to an embodiment of the disclosure. As illustrated in FIG. 3, flexible joint 300 is substantially similar to flexible joint 200. Flexible joint 300 includes an upper body 302, a lower body 304, a riser bearing 306 having a high shape factor, and a nipple 308, all of which are substantially similar to the upper body 202, lower body 204, riser bearing 206, and nipple 208, respectively, of flexible joint 200. The bellows seal 310 is disposed between an upper nipple surface 312 of the nipple 308 and a lower mounting surface 314 of the upper body 302. The bellows seal 310 also surrounds an elongated lower portion 312 of the upper body 302, thus segregating an internal space of the bellows seal 310 from a riser bearing cavity 320. The bellows seal 310 is formed from an impermeable material to substantially prevent hydrocarbon fluids and/or gases flowing through a central bore 318 of the flexible joint 300 that may pass between mating surfaces of the upper body 302 and the nipple 308 from penetrating into the riser bearing cavity 320. In some embodiments, the bellows seal 310 has a thin, flexible membrane that is formed from a corrosion resistant alloy. However, in some embodiments, the bellows seal 310 may be formed from Inconel. Additionally, the bellows seal 310 is pressure-balanced with a production fluid disposed between the elongated lower portion 316 of the upper body 302 and an inert fluid disposed within the riser bearing cavity 320.

In operation, flexible joint 300 performs substantially similar to flexible joint 200. However, flexible joint 300 has a larger structure to accommodate the bellows seal 310. The bellows seal 310 is configured to provide an additional layer of protection to the riser bearing 306 that may prevent well fluids such as hydrocarbon fluids and/or gases flowing from the central bore 318 and into contact with the riser bearing 306.

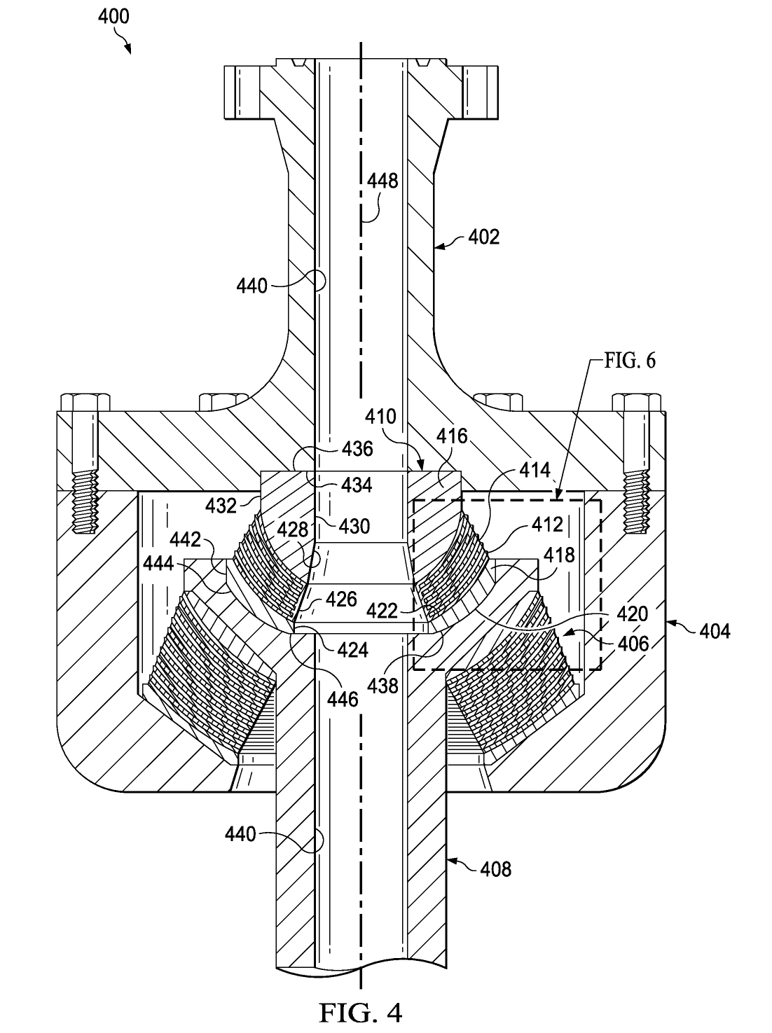

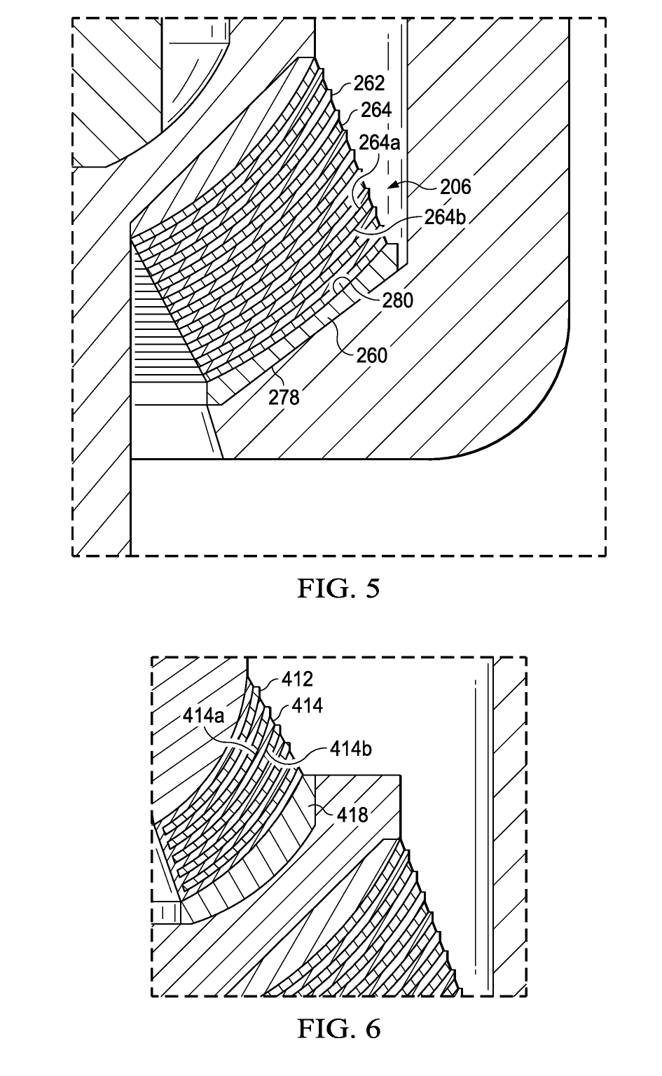

Referring now to FIG. 4, an orthogonal cross-sectional side view of a flexible joint 400 comprising a seal bearing 410 is shown according to an embodiment of the disclosure. It will be appreciated that flexible joint 400 is substantially similar to flexible joint 200. Flexible joint 400 comprises an upper body 402, a lower body 404, a riser bearing 406 comprising a high shape factor, and a nipple 408, all of which are substantially similar to the upper body 202, lower body 204, riser bearing 206, and nipple 208, respectively, of flexible joint 200. The seal bearing 410 comprises an inner sealing member 416, an outer sealing member 418, a plurality of elastomeric seal elements 412, and a plurality of intermediate seal shims 414 disposed between adjacent elastomeric seal elements 412. Elastomeric seal elements 412 and intermediate seal shims 414 are substantially similar to elastomeric elements 262 and intermediate shims 264, respectively. Intermediate seal shim 414 has a first seal side 414a and a second seal side 414b.

The inner sealing member 416 comprises a mating surface 434 that is configured to be received within an upper body receiving bore 436. The inner sealing member 416 comprises a central bore 430 that is substantially axially aligned with a central bore 440 of the flexible joint 400. In some embodiments, the inner sealing member 416 may also comprise a transition bore 428 extending from the central bore 430 and increasing in diameter towards a lower end of the inner sealing member 416. The inner sealing member 416 also includes a bonding surface 432 that has a substantially convex profile extending from the mating surface 434 to a transition bore 428 that is substantially coaxial with the central bore 430. The bonding surface 432 is configured to bond to at least one elastomeric seal element 412. In some embodiments, the convex surface of the bonding surface 432 is configured to maintain a radial bend in a plurality of bonded elastomeric seal elements 412 and intermediate seal shims 414 that is complimentary to the convex profile of the bonding surface 432. In some embodiments, the inner sealing member 416 is formed from a steel alloy, such as alloys 4130 and 4140, stainless steel, aluminum, titanium, and/or any other suitable material.

The outer sealing member has a central bore 424 axially aligned with the central bore 440 of the flexible joint 400. The outer sealing member 418 is received within the nipple receiving bore 438 and configured to substantially mate with the receiving bore side surface 442, the receiving bore surface 444, and the receiving bore inner surface 446 of the nipple 408. The outer sealing member 418 comprises a substantially concave bonding surface 422 configured to bond with at least one elastomeric element 412. In some embodiments, the bonding surface 422 has a profile that is substantially of a different radius to the convex profile of the bonding surface 432. In some alternative embodiments, the substantially concave profile of the bonding surface 422 is configured to maintain a slight radial bend in a plurality of bonded elastomeric seal elements 412 and intermediate seal shims 414 that is complimentary to the concave profile of the shim surface 422. In some embodiments, the outer sealing member 418 is formed from a steel alloy, such as alloys 4130 and 4140, stainless steel, aluminum, titanium, and/or any other suitable material.

The seal bearing 410 has a plurality of elastomeric seal elements 412 and a plurality of intermediate seal shims 414 disposed between and bonded to adjacent elastomeric seal elements 412. The plurality of elastomeric seal elements 412 and plurality of intermediate seal shims 414 bonded together are bonded to the inner sealing member 416 and the outer sealing member 418 to form the seal bearing 410. The plurality of elastomeric seal elements 412 and the plurality of intermediate seal shims 414 are arranged and bonded together to comprise an inner spherical profile starting with the elastomeric seal element 412 bonded to the inner sealing member 416 and increasing in inner diameter up to the elastomeric seal element 412 that is bonded to the outer sealing member 418.

The elastomeric seal elements 412 are formed from an elastomeric material, including, but not limited to natural rubber, nitrile, or any other suitable flexible material. The intermediate seal shims 414 are formed from a steel alloy, such as alloys 4130 and 4140, stainless steel, aluminum, titanium, fabric and/or any other suitable material.

Still referring to FIG. 4, in operation, the seal bearing 410 performs substantially similarly to riser bearing 206 and provides substantially the same sealing function as the bellows seal 310 of flexible joint 300. As with riser bearing 206, when assembled, the seal bearing 410 includes a pre-loaded compression force on the elastomeric seal elements 412. However, in some embodiments, the connection of a fluid conduit, such as fluid conduit 102 in FIG. 1, may relieve and/or reduce such preloaded compressive forces on the elastomeric seal elements 412 of the seal bearing 410. In some embodiments, the seal bearing 410 is configured to provide a barrier between the bore 430 and the body 404 to prevent production fluids reaching the riser bearing 406.

During operation, the elastomeric seal elements 412 of the seal bearing 410 may be exposed to well fluids such as hydrocarbon fluids and/or gases flowing through the central bore 440. However, the seal bearing 410 comprises a high shape factor design that is similar to the high shape factor design of the riser bearing 206 of the flexible joint 200. Similarly to riser bearing 206, the seal bearing 410 improves resistance to and/or resists rapid gas decompression damage. Accordingly, the enhanced resistance to gas permeation into the elastomeric seal elements 412, as a result of the high shape factor, prevents and/or significantly reduces exposure of the riser bearing 406 to well fluids such as hydrocarbon fluids and/or gases flowing through the central bore 440. Generally, the seal bearing 410 comprises a shape factor of at least about 10. However, seal bearing 410 may have a shape factor between 10 to about 40.

Other embodiments of the current invention will be apparent to those skilled in the art from a consideration of this specification or practice of the invention disclosed herein. Thus, the foregoing specification is considered merely exemplary of the current invention with the true scope thereof being defined by the following claims.

What is claimed is:

1. A riser bearing, comprising:
an inner bonding member;
an outer bonding member;
at least one elastomeric element bonded between the inner bonding member and the outer bonding member; and
wherein the elastomeric element has a high shape factor.

2. The riser bearing of claim 1, further comprising:
at least one intermediate shim having a first side and a second side;
a plurality of the elastomeric elements; and
wherein at least one elastomeric element is bonded between the inner bonding member and the first side of the at least one intermediate shim and at least one elastomeric element bonded between the outer bonding member and the second side of the at least one intermediate shim.

3. The riser bearing of claim 1, wherein the inner bonding member has a convex surface and the outer bonding member has a concave surface.

4. The riser bearing of claim 1, wherein the elastomeric element has a high shape factor of about 15.

5. The riser bearing of claim 1, wherein the elastomeric element has a high shape factor of about 20.

6. The riser bearing of claim 1, wherein the elastomeric element has a high shape factor of about 25.

7. The riser bearing of claim 1, wherein the elastomeric element has a high shape factor between about 10 and about 40.

8. The riser bearing of claim 6, wherein the elastomeric element has a high shape factor of about 10.

9. The riser bearing of claim 6, wherein the elastomeric element has a high shape factor of about 15.

10. The riser bearing of claim 1, further comprising a stacked bonded arrangement of a plurality of elastomeric elements and a plurality of intermediate member disposed between adjacent elastomeric elements, wherein each of the plurality of elastomeric elements have a high shape factor between about 10 to about 40.

11. A flexible joint, comprising:
a body;
a nipple;
a riser bearing, the riser bearing further comprising:
an inner bonding member;
an outer bonding member;
at least one elastomeric element bonded between the inner bonding member and the outer bonding member; and
wherein the elastomeric element has a high shape factor.

12. The flexible joint of claim 11, wherein the inner bonding member has a convex surface and the outer bonding member has a concave surface.

13. The flexible joint of claim 11, wherein the elastomeric element has a high shape factor of at least about 15.

14. The flexible joint of claim 11, wherein the elastomeric element has a high shape factor of at least about 20.

15. The flexible joint of claim 11, wherein the elastomeric element has a high shape factor of at least about 25.

16. The riser bearing of claim 11, wherein the elastomeric element has a high shape factor between about 10 and about 40.

17. The riser bearing of claim 16, wherein the elastomeric element has a high shape factor between about 15.

18. The flexible joint of claim 11, further comprising a bellows seal.

19. The flexible joint of claim 11, wherein the flexible joint is configured to connect to a fluid conduit at a first end and configured to connect to a conduit at a second end.

20. The flexible joint of claim 11, wherein the flexible joint is configured for use in an offshore hydrocarbon production system.

21. A flexible joint having a seal, the flexible joint comprising:
a body;
a nipple;
a riser bearing, the riser bearing including:
an inner bonding member;
an outer bonding member;
at least one elastomeric element bonded between the inner bonding member and the outer bonding member;
a seal bearing including:
an inner sealing member;
an outer sealing member;
at least one elastomeric seal element bonded between the inner sealing member and the outer sealing member; and
wherein the elastomeric seal element has a high shape factor.

22. The flexible joint of claim 21, wherein the riser bearing further comprises:
at least one intermediate shim having a first side and a second side;
a plurality of the elastomeric elements; and
wherein at least one elastomeric element is bonded between the inner bonding member and the first side of the at least one intermediate shim and at least one elastomeric element bonded between the outer bonding member and the second side of the at least one intermediate shim.

23. The flexible joint of claim 21, wherein the sealing bearing further comprises:
at least one intermediate seal shim having a first seal side and a second seal side;
a plurality of the elastomeric seal elements; and
wherein at least one elastomeric seal element is bonded between the inner sealing member and the first seal side of the at least one intermediate seal shim and at least one elastomeric seal element bonded between the outer sealing member and the second seal side of the at least one intermediate seal shim.

24. The flexible joint of claim 21, wherein the elastomeric seal element has a high shape factor of at least about 10.

25. The flexible joint of claim 21, wherein the elastomeric seal element has a high shape factor of at least about 15.

26. The flexible joint of claim 21, wherein the elastomeric seal element has a high shape factor of at least about 20.

27. The flexible joint of claim 21, wherein the elastomeric seal element has a high shape factor of at least about 25.

28. The riser bearing of claim 21, wherein the elastomeric seal element has a high shape factor between about 10 and about 40.

29. The riser bearing of claim 28, wherein the elastomeric seal element has a high shape factor of about 10.

30. The flexible joint of claim 21, wherein the flexible joint is configured to connect to a fluid conduit at a first end and configured to connect to a conduit at a second end.
